(19) United States
(12) Patent Application Publication
(10) Pub. No.: US 2004/0117501 A1
(43) Pub. Date: Jun. 17, 2004

(54) Apparatus and method for correction of textual information based on locale of the recipient

(75) Inventors: Don Rutledge Day, Austin, TX (US); David Allen Schell, Durham, NC (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY (US)

(21) Appl. No.: 10/317,986

(22) Filed: Dec. 12, 2002

(51) Int. Cl. G06F 15/16

(52) U.S. Cl. 709/232

(57) ABSTRACT

An apparatus and method for correction of textual information based on locale of the recipient are provided. With the apparatus and method, a user inputs a textual message having locale sensitive information. The textual message is parsed to identify candidate segments that may include locale sensitive information. These segments are then analyzed using one or more rules to identify whether one or more of these candidate segments include locale sensitive information and the type of locale sensitive information that is included in these segments. The locale sensitive information is then converted to a standard representation based on the locale sensitive information and its type. The standardized version of the textual message is then transmitted to the recipient where a similar process occurs. That is, the textual message is again parsed to identify candidate segments that may include locale sensitive information. The candidate segments are then analyzed to determine if they include locale sensitive information and what type of locale sensitive information they include. The locale sensitive information is then converted to a locale dependent version based on the locale of the recipient. The resulting textual message is then output with the locale dependent version of the locale sensitive information inserted therein.

### BACKGROUND OF THE INVENTION

1. Technical Field

The present invention is directed to an apparatus and method for correction of textual information based on locale of the recipient. More specifically, the present invention is directed to an apparatus and method for changing locale sensitive portions of textual data from a first representation to a second representation specific to the locale of the recipient of the textual information.

2. Description of Related Art

Typically, in messaging systems, such as electronic mail, chat websites, instant messaging, and short messaging systems, parties must perform their own conversion of locale sensitive information when generating messages. For example, if a first party, located in Texas wishes to coordinate an activity with another party in Virginia, the first party must be aware of the time difference between Texas and Virginia in order to send a message identifying the time of the activity in terms of Eastern Standard Time (EST) rather than Central Standard Time (CST). Similarly, if a first party in the United States of America wishes to convey information regarding monetary units to a party in Japan, the first party may be required to be aware of the current exchange rate in order to convert United States dollars to Japanese yen. It is clear that if the party sending the message is not aware of the time difference, exchange rate, and other locale sensitive information, the communication between parties may be strained.

Thus, it would be beneficial to have an apparatus and method for automatic correction of textual information based on locale of the recipient. That is, it would be beneficial to have an apparatus and method for automatically identifying locale sensitive information in the textual information and changing that locale sensitive information into a form that is more understandable by the recipient based on the locale of the recipient.

### SUMMARY OF THE INVENTION

The present invention provides an apparatus and method for correction of textual information based on locale of the recipient. With the apparatus and method of the present invention, a user inputs a textual message having locale sensitive information. The textual message is parsed to identify candidate segments that may include locale sensitive information. These segments are then analyzed using one or more rules to identify whether one or more of these candidate segments include locale sensitive information and the type of locale sensitive information that is included in these segments. The locale sensitive information is then converted to a standard representation based on the locale sensitive information and its type.

The standardized version of the textual message is then transmitted to the recipient where a similar process occurs. That is, the textual message is again parsed to identify candidate segments that may include locale sensitive information. The candidate segments are then analyzed to determine if they include locale sensitive information and what type of locale sensitive information they include. The locale sensitive information is then converted to a locale dependent version based on the locale of the recipient. The resulting textual message is then output with the locale dependent version of the locale sensitive information inserted therein.

Thus, with the present invention, users may input text messages in a manner that they would if they were sending the text message to another party in their same locale. In other words, the user is not required to understand the differences between his/her locale and the locale of the receiving party. The present invention automatically converts locale sensitive information in the text message so that the receiving party will understand the text message in the context of his/her own locale.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in which the present invention may be implemented;

FIG. 2 is an exemplary block diagram of a server computing device in accordance with the present invention;

FIG. 3 is an exemplary block diagram of a client computing device in accordance with the present invention;

FIG. 4 is an exemplary diagram illustrating an overall operation of the present invention;

FIG. 5 is an exemplary block diagram of the primary operational components of the present invention;

FIG. 6 is a diagram illustrating a data flow for an example textual message in accordance with the present invention; and

FIG. 7 is a flowchart outlining an exemplary operation of the present invention.

### DETAILED DESCRIPTION OF THE PREFERRED EMBODIMENT

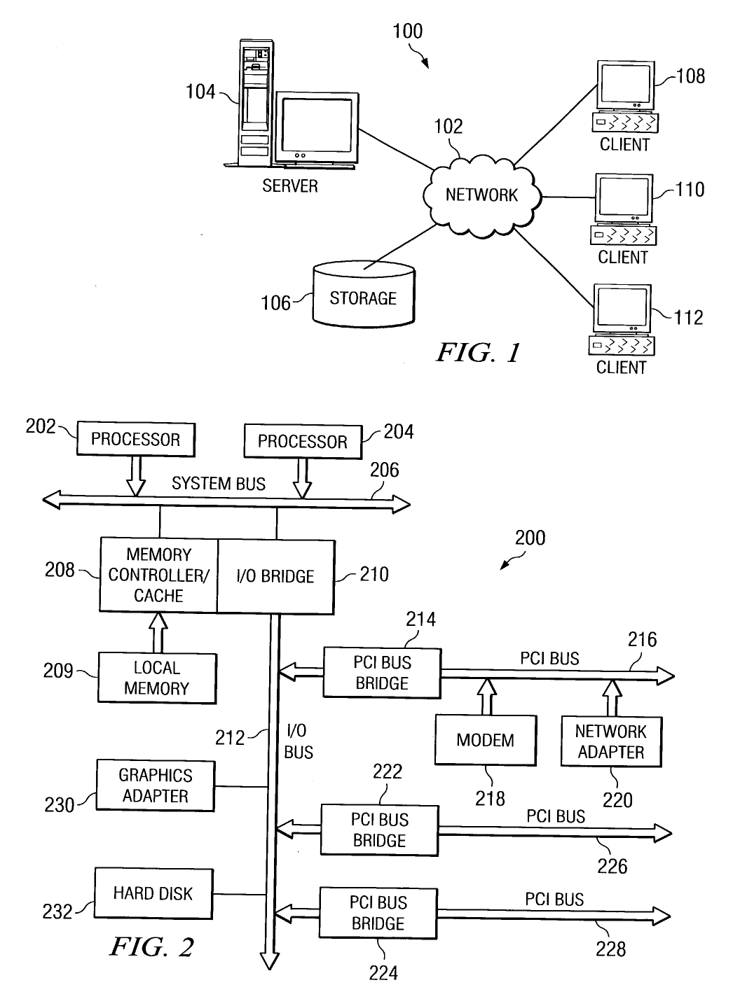

The preferred embodiments of the present invention are implemented in a distributed data processing environment in which a computing system to which access is sought acts as a client and a server that performs validation of the device identifiers acts as server to the client. As such, FIGS. 1-3 are provided hereafter as exemplary of the environment and hardware devices in which the present invention may be implemented.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed.

Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

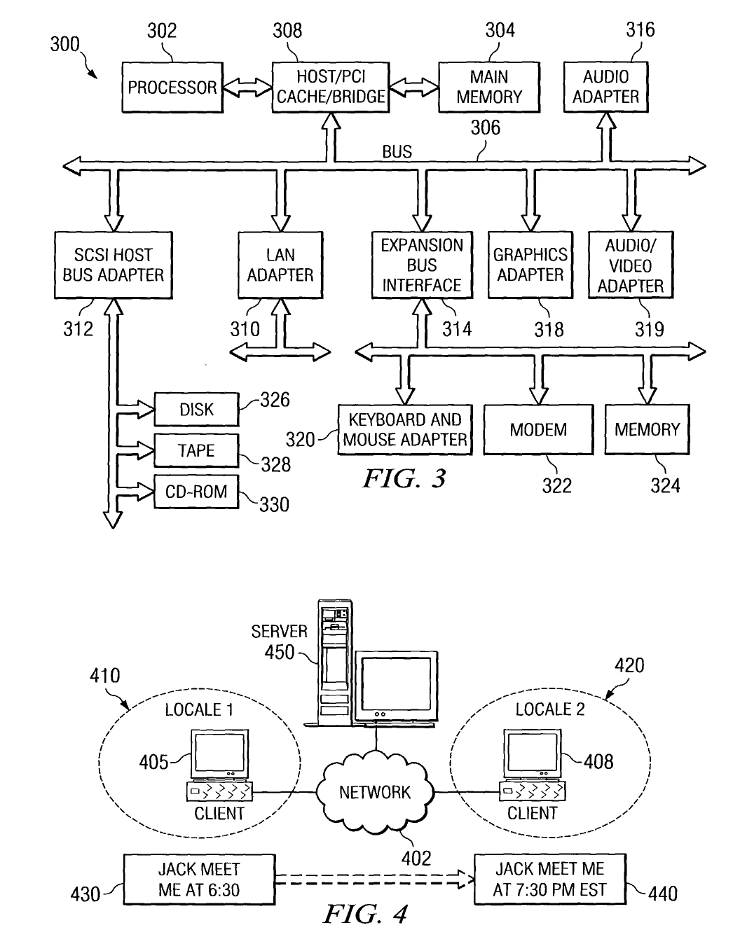

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used.

Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned previously, the present invention provides a mechanism for automatically converting or correcting text data having locale sensitive data into a representation specific to the locale of the recipient of the text data. The term “locale” as it is used in the present description is meant to refer to a geophysical location of a computing device. The term “locale” is not necessarily limited to time zones, country borders, or the like. Any geophysical location may be used as a “locale” in the present invention. Thus, for example, regions within the same time zone and the same country may constitute different locales in the context of the present invention.

The present invention may be used in conjunction with many different textual messaging systems generally known in the art. For example, the present invention may be added to an electronic mail system, an instant messaging system, a chat system, an alphanumeric pager system, a short messaging system (SMS) typically found in cellular telephone systems and pagers, e.g., DOCOMO, and the like. Alternatively, the present invention may be offered as a service in the network through which such textual messages are transmitted. For example, a server may be provided that includes the features of the present invention. This server may intercept textual messages, such as in the normal activity of routing the textual messages, and perform the functions described hereafter to convert a received textual message into a standard form or even a form that is specific to the locale of the receiving party.

FIG. 4 illustrates the overall operation of the present invention from the view of a distributed data processing system. A shown in FIG. 4, a first client device 405 is located in a first locale 410 and a second client device 408 is located in a second locale 420. The client devices 405 and 408 may be any computing device that is capable of sending and receiving text messages. For example, the client devices 405 and 408 may be personal computers, personal digital assistants, wireless communication devices, e.g., cellular telephones or pagers, laptop computers, or the like.

The two client devices 405 and 408 may communicate with one another over the network 402. The server 450 is provided for facilitating the conversion of locale sensitive information in some embodiments and/or providing locale conversion information, e.g., currency exchange rates, necessary for converting the locale sensitive information in other embodiments.

For example, in one embodiment of the present invention, the server 450 may provide all of the functionality of the present invention as a service to the client devices 405 and 408. That is text messages are transmitted between the client devices 405 and 408 via the server 450 which performs the functions of the present invention to convert locale sensitive information to a locale specific representation before routing the text message to the recipient client device. This may require that the client devices 405 and 408 register with the server 450 and provide locale information, such as time zone, country identifier, device identifier, e.g., IP address, MAC address, etc., for use in performing such a conversion. When a text message is received, the device identifier may be used as a way of looking up, in the server's registry of client devices, the locale information for the source client device and/or the destination client device in order to perform the conversion. The additional information used by the server 450 to perform such conversions may include, for example, the current exchange rate for currency between locale 410 and locale 420.

Alternatively, the present invention may be implemented entirely within the client devices 405 and 408 themselves without the need for the server 450. In such embodiments, the server 450 may not be used at all or may be used simply to retrieve additional information, such as exchange rates for currency, to be used in converting locale sensitive information.

As shown in FIG. 4, the ultimate goal of the present invention is to allow a user at a first client device 405 in a first locale 410 to enter a text message in the manner the user would normally do so when sending text messages to other client devices in the same locale and have the locale sensitive information in the text message be automatically converted to a representation appropriate for the second locale 420. In the depicted example, a user of client device 405 enters the text message 430 having the text “Jack meet me at 6:30.” This message is then converted to the text message 440 having the text “Jack meet me at 7:30 PM EST” by the present invention in view of the time difference between locale 410 and locale 420.

With the apparatus and method of the present invention, a user inputs a textual message into a computing device, wherein the textual message includes locale sensitive information. This textual message may be, for example, an electronic mail message, an instant message, a chat message, a textual message entered via a cellular telephone or pager, or the like.

Locale sensitive information is any information whose form or content will typically change based on the particular locale of the user. Examples of locale sensitive information include, but are not limited to, time, date and currency. That is, if a time of 6:30 PM is entered in a first locale, such as Texas, in Virginia this same time is 7:30 PM due to a difference in time zones. Moreover, in different countries, the time may be written in a different form, such as 1830 hours or 6.30 PM.

Likewise, if a date of May 6, 2002 is entered in the United States, this date in Europe will be written as 6 May 2002. With currency, various symbols may be used to denote currency denominations and currency will be different based on exchange rates. Thus, depending on the particular locale of the recipient, different monetary units and amounts of currency (depending on the exchange rate) may be used.

With the present invention, either the computing device to which the textual message is input, or a server on the network, parses the textual message to identify candidate segments that may include locale sensitive information. For purposes of illustration, the following described embodiments will assume that the functions of the present invention are performed in the client devices, or computing devices, themselves rather than in a server on a network. However, the computing devices may make use of information obtained from servers on the network to aid in the conversion of the locale sensitive information, e.g., currency exchange rates may be retrieved from servers in order to perform currency conversion in the text message.

A database of patterns that indicate locale sensitive information is established and used during the parsing of the text data to identify segments of the text data that may include locale sensitive information. For example, the text data may be tokenized, i.e. broken up into segments or tokens, and the text data in each segment or token then compared to the list of patterns in the pattern database. If a segment includes one or more of the patterns, then the segment is indicated as being a candidate segment for having locale sensitive information therein.

For example, the text data segments may each be compared to pattern information such as “$”, “:”, “PM”, “AM”, “EST” or the like. If a text data segment or token includes one or more of these patterns, the text data segment is marked as a candidate segment for having locale sensitive information.

The candidate text data segments are then analyzed using the pattern database, system information, and one or more rules to identify whether one or more of these candidate segments include locale sensitive information and the type of locale sensitive information that is included in these segments. The analysis may be based on a more extensive pattern database in which more complex patterns are used to provide a more accurate determination of whether the segment includes locale sensitive information. These patterns may have an associated locale information type which may then be used to determine how the locale information is to be converted to a standardized representation.

Moreover, information may be obtained from the computing device operating system to identify current settings of the computing device, e.g., central standard time, eastern standard time, country identification, etc. All of this information together may be used to determine the type of locale sensitive information included in the text message and the locale of source computing device from which the text message is received. The rules may then be applied based on the type of locale sensitive information and the locale of the source computing device to thereby perform functions to convert the locale sensitive information into a standard representation, such as an ISO standard time representation, Greenwich Mean Time (GMT) representation, a standard currency representation, such as U.S. dollars, and the like. An example of such a rule is that if the locale sensitive information is time information and the locale from which it was sent is the Central Time Zone, in order to convert this time to the ISO standard, a particular set of functions are performed on the locale sensitive information.

It should be noted that conversion to a standard representation is provided as a means for reducing error in the conversion from the source locale representation to the destination locale representation of the locale sensitive information. However, in some embodiments, the conversion to a standard representation may be eliminated and the text message sent to the recipient with the source locale representation intact. In such an embodiment, the conversion is performed in the destination computing device from a source locale representation to a destination locale representation.

Of course, with such an embodiment, information about the source locale representation must be provided with the message or otherwise obtainable based on the message, such as from a sender list which may be used to lookup the locale of a particular sender of a message. Without some additional information regarding the source locale, it may not be possible for the destination device to accurately convert the source locale representation to the destination local representation. One of the benefits of converting the source locale representation to a standardized representation is that the “standardized locale” is always known to the destination device. Thus, the destination device need only be able to convert from standardized locale to its own locale and need not have any information regarding the sender's locale.

Moreover, in the case of a server implementation of the present invention where both the source of the text message and the destination of the text message are registered with the server, the conversion to a standard representation may not be necessary and the conversion may be made directly from a source locale representation to a destination locale representation. However, for purposes of the description of the present invention, it will be assumed that conversion is from a source locale representation of the locale sensitive information, to a standard representation, and from the standard representation to the destination locale representation.

Once the standardized representation of the locale sensitive information is generated and used to replace the source locale representation in the text message, the text message is transmitted to the destination computing device where a similar process occurs. That is, the text message is again parsed to identify candidate segments that may include locale sensitive information. The candidate segments are then analyzed to determine if they include locale sensitive information and what type of locale sensitive information they include. The locale sensitive information is then converted to a destination locale representation based on the locale of the destination computing device. The resulting text message is then output with the destination locale representation of the locale sensitive information inserted therein.

The particular destination locale representation to which the standard representation is converted may be determined based on similar destination computing device information, rules, and the like, used to convert the source locale representation to the standard representation. In addition, user preferences may be established for determining how to represent standardized locale sensitive information on the destination computing device. For example, these user preferences may include settings such as whether a 12 hour or 24 hour clock is to be used, the particular time separator to be used, the particular monetary units to be used, etc. In addition, the user preferences may include settings as to whether conversion of locale sensitive information is to be performed at all and whether to show the original locale information along with the converted locale information, such as in parentheses.

It should be noted that there are some text data that may appear to be locale sensitive information but in fact is not. For example, an elapsed time may resemble locale sensitive time but in fact, regardless of the locale, the same amount of time will have elapsed. The pattern database and rules of the present invention may be established with sufficient patterns and rules for determining such text data and handle it accordingly, i.e. by not converting it.

Thus, the present invention provides an automated mechanism for converting locale sensitive information from a source locale representation to a destination locale representation. The present invention may be implemented in client devices, one or more servers, or a combination of client devices and one or more servers.

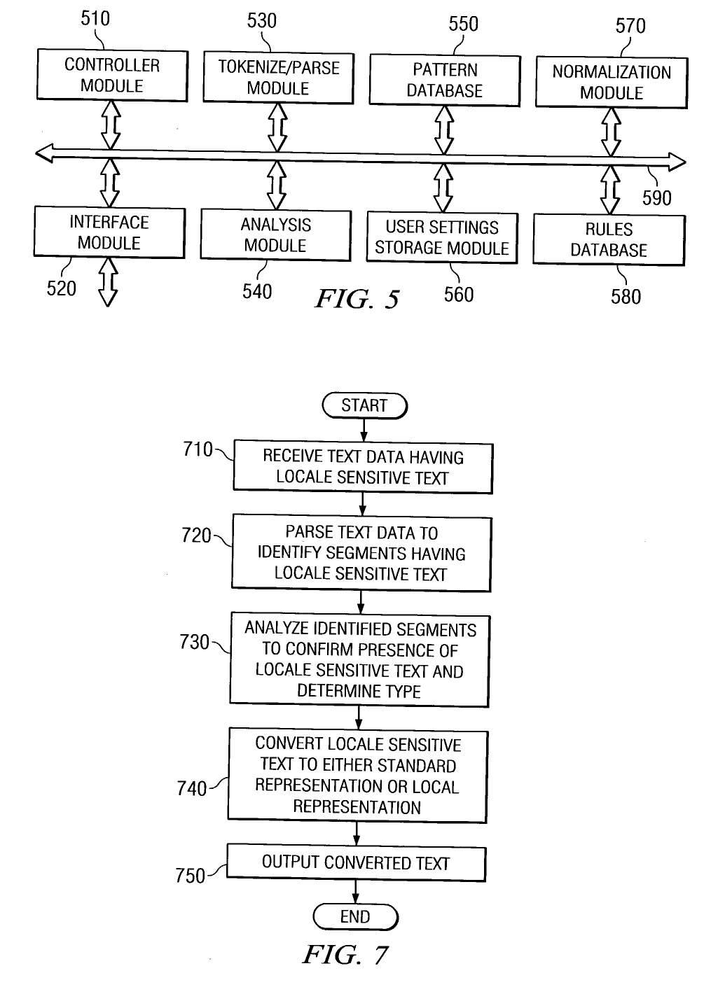

FIG. 5 is an exemplary block diagram of the primary operational components of the present invention. The elements shown in FIG. 5 may be implemented as software, hardware, or any combination of software and hardware without departing from the spirit and scope of the present invention. In a preferred embodiment, the elements of FIG. 5 are implemented as software instructions executed by one or more processors.

As shown in FIG. 5, the locale sensitive information conversion apparatus of the present invention includes a controller module 510, an interface module 520, a tokenize/parse module 530, an analysis module 540, a pattern database 550, a user settings storage module 560, a conversion module 570, and a rules database 580. The elements 510-580 are in communication with one another via the control/data signal bus 590.

The controller module 510 controls the overall operation of the apparatus and orchestrates the operation of the other elements 520-580. The interface module 520 provides an input/output interface through which text messages are received, user input is received, and converted text messages are output.

The tokenize/parse module 530 breaks up a received text message into segments and parses each segment to identify candidate segments that may have locale sensitive text therein. The analysis module 540 analyzes the candidate segments to identify those that do have locale sensitive text and to identify the type of locale sensitive text that is included in those candidate segments. The tokenize/parse module 530 and analysis module 540 may make use of patterns obtained from the pattern database 550, system information obtained from the computing system via the interface module 520, and rules obtained from the rules database 580.

The conversion module 570 converts the locale sensitive information into either a standardized representation of the locale sensitive information and a locale representation. If the text message is received from another computing device and the locale sensitive information is indicated as being in standardized form, then the conversion module 570 converts the standardized locale sensitive information into a locale representation. Otherwise, if the text message is input by a user of the computing device on which the apparatus of FIG. 5 is resident, then the conversion is from a locale representation to a standardized representation. The particular conversion performed is governed by rules retrieved from the rules database based on the type of locale information identified by the analysis module 540, system information retrieved via the interface module 520, and user settings set in the user settings storage module 560.

The conversion module 570 outputs the converted locale information to the controller module 510 which then integrates this converted locale information back into the text message in place of the original locale information. The controller module 510 then outputs the converted text message via the interface 520.

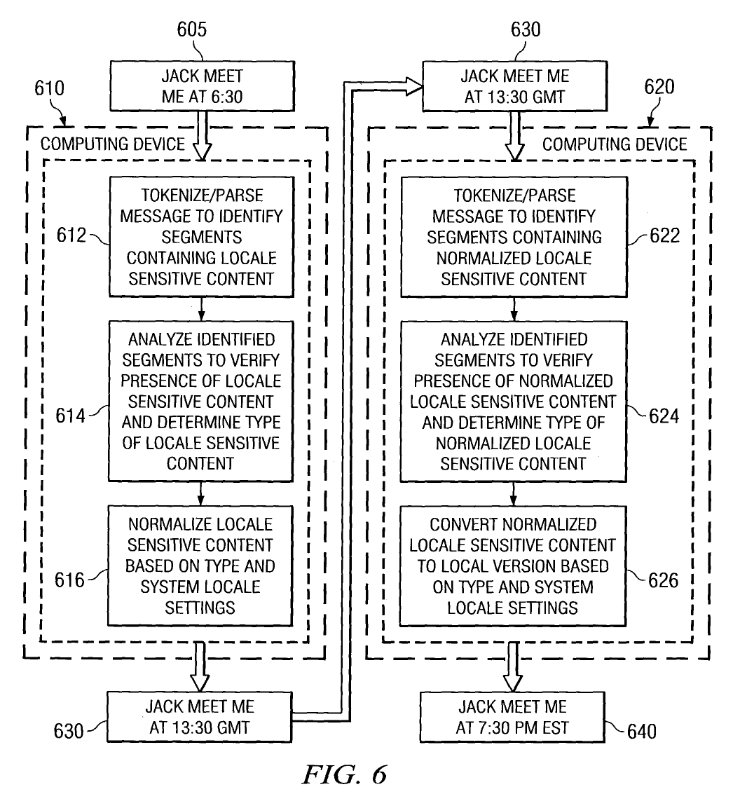

FIG. 6 is a diagram illustrating a data flow for an example text message in accordance with the present invention. As shown in FIG. 6, a user inputs the text message “Jack meet me at 6:30” 605 using a first computing device 610 and instructs the first computing device to transmit the message to the second computing device 620. In response, the apparatus of the present invention tokenizes and parses the message to identify segments containing locale sensitive content (612). The segments are then analyzed to identify segments that actually do contain locale sensitive information and the type of locale sensitive information that they do contain (614). The locale information is then normalized based on the type of locale information and the system locale settings (616). The standardized text message “Jack meet me at 13:30 GMT” 630 is then output to the second computing device 620.

The second computing device 620 receives the standardized text message 630 and again tokenizes and parses the text message to identify segments having locale sensitive information (622). The segments are then analyzed to identify segments that actually do contain locale sensitive information and the type of locale sensitive information that they do contain (624). The locale information is then converted to a local representation based on the type of locale information and the system locale settings (626). The text message “Jack meet me at 7:30 PM EST” 640 having the locale representation of the locale sensitive information is then output via the second computing device 620. Such output may take the form of a textual display or an audible output, as is generally known in the art.

FIG. 7 is a flowchart outlining an exemplary operation of the present invention. A shown in FIG. 7, the operation starts with text data being received that has locale sensitive text (step 710). The text data is parsed to identify segments having locale sensitive text (step 720). The identified segments are then analyzed to confirm the presence of locale sensitive text and determine the type of locale sensitive text that is included therein (step 730). The locale sensitive text is then converted to either a standardized representation or a local representation (step 740). The converted text is then output (step 750).

Thus, with the present invention, users may input text messages in a manner that they would if they were sending the text message to another party in their same locale. In other words, the user is not required to understand the differences between his/her locale and the locale of the receiving party. The present invention automatically converts locale sensitive information in the text message so that the receiving party will understand the text message in the context of his/her own locale.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a computing device, for converting locale sensitive data in textual data, comprising:
receiving textual data, the textual data including locale sensitive data;
identifying the locale sensitive data in the textual data;
automatically converting the locale sensitive data in the textual data from a first representation to a second representation to thereby generate converted locale sensitive data;
replacing the locale sensitive data in the textual data with the converted locale sensitive data; and
outputting the textual data having the converted locale sensitive data.

2. The method of claim 1, wherein the locale sensitive data includes at least one of time data, currency data, and date data.

3. The method of claim 1, wherein automatically converting the locale sensitive data includes converting the locale sensitive data from a locale representation for a source computing device to a standardized representation.

4. The method of claim 1, wherein automatically converting the locale sensitive data includes converting the locale sensitive data from a standardized representation to a locale representation for a destination computing device.

5. The method of claim 1, wherein automatically converting the locale sensitive data includes converting the locale sensitive data from a first locale representation corresponding to a source locale to a second locale representation corresponding to a destination locale.

6. The method of claim 1, wherein the standardized representation is one of a Greenwich Mean Time (GMT) representation and International Organization for Standardization representation.

7. The method of claim 1, further comprising:
retrieving locale conversion information from a source device, wherein automatically converting the locale sensitive data in the textual data from a first representation to a second representation includes using the locale conversion information to perform the conversion from the first representation to the second representation.

8. The method of claim 7, wherein the locale conversion information is currency exchange rate information.

9. The method of claim 7, wherein the source device is a third party supplier of locale conversion information.

10. The method of claim 1, wherein the textual data is one of an instant messaging message, a chat message, an alphanumeric pager message, a short messaging system message, and an electronic mail message.

11. The method of claim 1, wherein the computing device is one of a source client device and a destination client device.

12. The method of claim 1, wherein the computing device is a server, the textual data is received from a source computing device, and the textual data having the converted locale sensitive data is output to a destination computing device.

13. The method of claim 1, further comprising:
identifying a source computing device from which the textual data is received; and
identifying locale information for the source computing device in a registry, wherein automatically converting the locale sensitive data includes using the locale information for the source computing device to convert the locale sensitive data.

14. The method of claim 1, wherein identifying the locale sensitive data in the textual data includes:
parsing the textual data to identify one or more candidate segments that may include locale sensitive data; and
analyzing the one or more candidate segments to verify that the one or more candidate segments include locale sensitive data.

15. The method of claim 14, wherein identifying the locale sensitive data in the textual data further includes:
analyzing the one or more candidate segments to identify the type of locale sensitive data included therein, wherein automatically converting the locale sensitive data includes converting the locale sensitive data based on the identified type of locale sensitive data.

16. The method of claim 15, wherein at least one of analyzing the one or more candidate segments to verify that the one or more candidate segments include locale sensitive data and analyzing the one or more candidate segments to identify the type of locale sensitive data included therein includes using local patterns retrieved from a pattern database.

17. The method of claim 15, wherein at least one of analyzing the one or more candidate segments to verify that the one or more candidate segments include locale sensitive data and analyzing the one or more candidate segments to identify the type of locale sensitive data included therein includes retrieving and using system information.

18. A computer program product in a computer readable medium for converting locale sensitive data in textual data, comprising:
first instructions for receiving textual data, the textual data including locale sensitive data;
second instructions for identifying the locale sensitive data in the textual data;
third instructions for automatically converting the locale sensitive data in the textual data from a first representation to a second representation to thereby generate converted locale sensitive data;
fourth instructions for replacing the locale sensitive data in the textual data with the converted locale sensitive data; and
fifth instructions for outputting the textual data having the converted locale sensitive data.

19. The computer program product of claim 18, wherein the locale sensitive data includes at least one of time data, currency data, and date data.

20. The computer program product of claim 18, wherein the third instructions for automatically converting the locale sensitive data include instructions for converting the locale sensitive data from a locale representation for a source computing device to a standardized representation.

21. The computer program product of claim 18, wherein the third instructions for automatically converting the locale sensitive data include instructions for converting the locale sensitive data from a standardized representation to a locale representation for a destination computing device.

22. The computer program product of claim 18, wherein the third instructions for automatically converting the locale sensitive data include instructions for converting the locale sensitive data from a first locale representation corresponding to a source locale to a second locale representation corresponding to a destination locale.

23. The computer program product of claim 18, further comprising:
sixth instructions for retrieving locale conversion information from a source device, wherein the third instructions for automatically converting the locale sensitive data in the textual data from a first representation to a second representation include instructions for using the locale conversion information to perform the conversion from the first representation to the second representation.

24. The computer program product of claim 18, wherein the textual data is one of an instant messaging message, a chat message, an alphanumeric pager message, a short messaging system message, and an electronic mail message.

25. The computer program product of claim 18, further comprising:
sixth instructions for identifying a source computing device from which the textual data is received; and
seventh instructions for identifying locale information for the source computing device in a registry, wherein the third instructions for automatically converting the locale sensitive data include instructions for using the locale information for the source computing device to convert the locale sensitive data.

26. The computer program product of claim 18, wherein the second instructions for identifying the locale sensitive data in the textual data include:
instructions for parsing the textual data to identify one or more candidate segments that may include locale sensitive data; and
instructions for analyzing the one or more candidate segments to verify that the one or more candidate segments include locale sensitive data.

27. The computer program product of claim 26, wherein the second instructions for identifying the locale sensitive data in the textual data further include:
instructions for analyzing the one or more candidate segments to identify the type of locale sensitive data included therein, wherein the third instructions for automatically converting the locale sensitive data include instructions for converting the locale sensitive data based on the identified type of locale sensitive data.

28. The computer program product of claim 27, wherein at least one of the instructions for analyzing the one or more candidate segments to verify that the one or more candidate segments include locale sensitive data and instructions for analyzing the one or more candidate segments to identify the type of locale sensitive data included therein include instructions for using local patterns retrieved from a pattern database.

29. The computer program product of claim 27, wherein at least one of the instructions for analyzing the one or more candidate segments to verify that the one or more candidate segments include locale sensitive data and instructions for analyzing the one or more candidate segments to identify the type of locale sensitive data included therein include instructions for retrieving and using system information.

30. An apparatus for converting locale sensitive data in textual data, comprising:
means for receiving textual data, the textual data including locale sensitive data;
means for identifying the locale sensitive data in the textual data;
means for automatically converting the locale sensitive data in the textual data from a first representation to a second representation to thereby generate converted locale sensitive data;
means for replacing the locale sensitive data in the textual data with the converted locale sensitive data; and
means for outputting the textual data having the converted locale sensitive data.

31. The apparatus of claim 30, wherein the locale sensitive data includes at least one of time data, currency data, and date data.

32. The apparatus of claim 30, wherein the means for automatically converting the locale sensitive data includes means for converting the locale sensitive data from a locale representation for a source computing device to a standardized representation.

33. The apparatus of claim 30, wherein the means for automatically converting the locale sensitive data includes means for converting the locale sensitive data from a standardized representation to a locale representation for a destination computing device.

34. The apparatus of claim 30, wherein the means for automatically converting the locale sensitive data includes means for converting the locale sensitive data from a first locale representation corresponding to a source locale to a second locale representation corresponding to a destination locale.

35. The apparatus of claim 30, wherein the standardized representation is one of a Greenwich Mean Time (GMT) representation and International Organization for Standardization representation.

36. The apparatus of claim 30, further comprising:
means for retrieving locale conversion information from a source device, wherein the means for automatically converting the locale sensitive data in the textual data from a first representation to a second representation includes means for using the locale conversion information to perform the conversion from the first representation to the second representation.

37. The apparatus of claim 36, wherein the locale conversion information is currency exchange rate information.

38. The apparatus of claim 36, wherein the source device is a third party supplier of locale conversion information.

39. The apparatus of claim 30, wherein the textual data is one of an instant messaging message, a chat message, an alphanumeric pager message, a short messaging system message, and an electronic mail message.

40. The apparatus of claim 30, wherein the computing device is one of a source client device and a destination client device.

41. The apparatus of claim 30, wherein the computing device is a server, the textual data is received from a source computing device, and the textual data having the converted locale sensitive data is output to a destination computing device.

42. The apparatus of claim 30, further comprising:
means for identifying a source computing device from which the textual data is received; and
means for identifying locale information for the source computing device in a registry, wherein automatically converting the locale sensitive data includes using the locale information for the source computing device to convert the locale sensitive data.

43. The apparatus of claim 30, wherein the means for identifying the locale sensitive data in the textual data includes:
means for parsing the textual data to identify one or more candidate segments that may include locale sensitive data; and
means for analyzing the one or more candidate segments to verify that the one or more candidate segments include locale sensitive data.

44. The apparatus of claim 43, wherein the means for identifying the locale sensitive data in the textual data further includes:
means for analyzing the one or more candidate segments to identify the type of locale sensitive data included therein, wherein the means for automatically converting the locale sensitive data includes means for converting the locale sensitive data based on the identified type of locale sensitive data.

45. The apparatus of claim 44, wherein at least one of the means for analyzing the one or more candidate segments to verify that the one or more candidate segments include locale sensitive data and the means for analyzing the one or more candidate segments to identify the type of locale sensitive data included therein includes means for using local patterns retrieved from a pattern database.

46. The apparatus of claim 44, wherein at least one of the means for analyzing the one or more candidate segments to verify that the one or more candidate segments include locale sensitive data and the means for analyzing the one or more candidate segments to identify the type of locale sensitive data included therein includes means for retrieving and using system information.
